(19) United States
(12) Patent Application Publication
(10) Pub. No.: US 2023/0215455 A1
(43) Pub. Date: Jul. 6, 2023

(54) DYNAMIC SIDE-TONE TO CONTROL VOICE CATEGORY

(71) Applicant: DSP Concepts, Inc., Santa Clara, CA (US)

(72) Inventor: Gints Klimanis, Cupertino, CA (US)

(21) Appl. No.: 18/089,660

(22) Filed: Dec. 28, 2022

Related U.S. Application Data
(60) Provisional application No. 63/295,060, filed on Dec. 30, 2021.

(51) Int. Cl. G10L 21/0364; G10L 25/18; G10L 17/26

(52) U.S. Cl. CPC G10L 21/0364; G10L 25/18; G10L 17/26

(57) ABSTRACT

A method for providing sidetone adjustment comprises generating an audio signal representing user speech, determining a spectral distribution of the audio signal, determining a voice category from the spectral distribution of the audio signal, applying an adjustment to the audio signal based on the determined voice category to generate an adjusted audio signal, and providing audio output based on the adjusted audio signal to the user as sidetone. The adjustment to the audio signal may comprise adjustments to a plurality of frequency bands in the audio signal. The adjustments may further comprise boosting the levels of frequency bands in a high frequency speech band.

### RELATED APPLICATION DATA

This application claims the benefit of U.S. Provisional Patent Application No. 63/295,060 filed on Dec. 30, 2022, the contents of which are incorporated herein as if explicitly set forth.

### BACKGROUND

Sidetone is a feedback mechanism that is used in audio communication devices that include an audio transducer that is positioned at a user's ear, such as a telephone handset, mobile phone or headset. A signal representing the user's voice, captured by a microphone in the device, is fed back to the audio transducer so that the user hears their own voice played back through the audio transducer(s). The level of the sidetone typically increases and decreases with the level of the user's voice. In this manner, sidetone provides an indication to the user of how loudly they are speaking, and can also provide additional benefits like indicating when a call has been dropped.

### BRIEF DESCRIPTION OF THE SEVERAL VIEWS OF THE DRAWINGS

Some embodiments of the present disclosure are illustrated by way of example and not limitation in the figures of the accompanying drawings, in which like reference numbers indicate similar elements. To easily identify the discussion of any particular element or act, the most significant digit or digits in a reference number refer to the figure number in which that element is first introduced.

FIG. 1 illustrates an example of a system in which a mobile phone communicates with a remote device over a network.

FIG. 2 illustrates the example wireless ear buds of FIG. 1 in more detail.

FIGS. 3A to 3C show charts of voice spectral composition for different demographic groups, according to some examples.

FIG. 4 is a schematic diagram showing a dynamic sidetone adjustment implementation according to some examples.

FIG. 5 illustrates a flowchart for providing dynamic sidetone adjustment according to some examples.

FIG. 6 illustrates a diagrammatic representation of a machine in the form of a computer system within which a set of instructions may be executed for causing the machine to perform any one or more of the methodologies discussed herein, according to some examples.

### DETAILED DESCRIPTION

A user may nevertheless speak too loudly even when conventional sidetone is present. Inadvertent loud-talking in telecommunications changes the nature of conversations, as well as stresses the talker and the far end listener. Such loud-talking occurs primarily under several conditions.

Firstly the talker may be unable to hear their own voice or the sidetone due to excessive environmental noise or long reverberation times. In such a case, the talker raises their voice to increase their transmission signal-to-noise ratio. This is known as the Lombard effect, and it may be distracting to the far end listener since much of the noise that is perceived by the talker may have been eliminated for the listener by noise reduction algorithms in the near-end device.

Secondly, the talker's perception of their own voice is altered due to the presence of headphone or headset earcups, due to the occlusion effect of such earcups. Closed-back headphones attenuate a projected voice by 10+ dB.

Thirdly, the near-talker may speak more loudly in response to the far-talker's signal-to-noise or voice level being too low, in an unconscious attempt to make the far talker speak more loudly or in the mistaken belief that the receive level at the far end is also too low.

Fourthly, in the Gints Effect, the user may alter their voice level as a function of perceived distance to the far-talker, present locally or remotely, in hopes of achieving an adequate voice level. This may be a 6-10 dB increase with the doubling of distance, subject to the limits of a person's ability to increase the midrange of their speech signal. Fifthly, the user may speak more loudly because there is distortion or latency in the channel.

To provide dynamic sidetone that attempts to address some of these problems, a voice category is determined from the user's voice as captured by a microphone in or associated with the communication device. Example voice categories are, in increasing order of sound pressure level (SPL) and tone stridency, Quiet, Normal, Raised, Loud, and Shouting. When inadvertent loud-talking is detected by the user's voice being classified into an undesirable voice category, the talker is influenced by the dynamic sidetone to use a more appropriate voice category. The influence is provided by a situationally-appropriate speech signal, derived from the user's voice in real-time, which is fed to the transmitting audio device's ear speakers. This process and the resulting signal are not applied to the transmit audio signal sent to the far end.

In some examples, disclosed is a method for providing sidetone adjustment, the method including receiving an audio signal representing speech of a user, determining a spectral distribution of the audio signal, determining a voice category from the spectral distribution of the audio signal, applying an adjustment to the audio signal based on the determined voice category, to generate an adjusted audio signal, and providing audio output based on the adjusted audio signal to the user as sidetone.

The adjustment to the audio signal may include adjustments to a plurality of frequency bands in the audio signal. The adjustments to the plurality of frequency bands may comprise boosting levels of one or more frequency bands in a high frequency speech range.

The method may further include determining a base audio adjustment for the audio signal based on a comparison between a level of the audio signal and a level of a further audio signal captured at or in an ear of the user.

The voice category may be determined by comparing a level of a low frequency speech band in the audio signal with a level of a mid-frequency speech band in the audio signal. In some examples the voice category is determined from a ratio of the level of the low frequency speech band and the level of a mid-frequency speech band.

The method may also include further include applying an additional gain to the audio output for louder voice categories.

In some examples, provided is a computing apparatus for providing sidetone adjustment, the computing apparatus includes one or more computer processors. The computing apparatus also includes one or more memories storing instructions that, when executed by the one or more computer processors, configure the computing apparatus to perform operations according to the methods, elements and limitations described above, including but not limited to receiving an audio signal representing speech of a user, determining a spectral distribution of the audio signal, determining a voice category from the spectral distribution of the audio signal, applying an adjustment to the audio signal based on the determined voice category, to generate an adjusted audio signal, and providing audio output based on the adjusted audio signal to the user as sidetone.

In some examples, provided is a non-transitory computer-readable storage medium, the computer-readable storage medium including instructions that when executed by one or more computer processors of one or more computing devices, cause the one or more computing devices to perform operations for providing sidetone adjustment according to the methods, elements and limitations described above, the operations including but not limited to receiving an audio signal representing speech of a user, determining a spectral distribution of the audio signal, determining a voice category from the spectral distribution of the audio signal, applying an adjustment to the audio signal based on the determined voice category, to generate an adjusted audio signal, and providing audio output based on the adjusted audio signal to the user as sidetone.

Other technical features may be readily apparent to one skilled in the art from the following figures, descriptions, and claims.

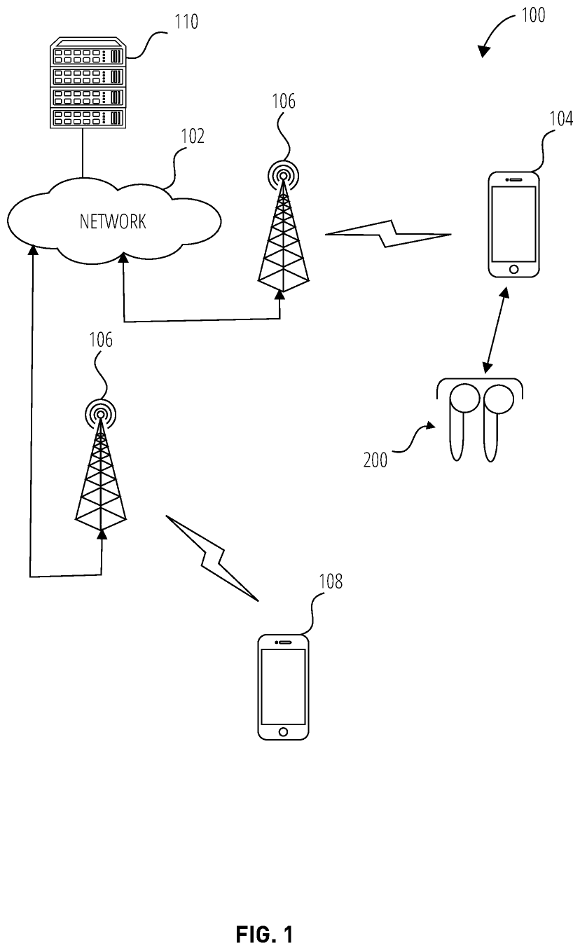

FIG. 1 illustrates an example of a system 100 in which a mobile phone 104 communicates with a remote device 108 over a network 102 including cell towers 106 and one or more servers 110. In some examples, the dynamic sidetone methods described herein are embodied in and performed in the mobile phone 104, or in an associated accessory device such as headphones, headsets, or wireless ear buds 200, or on the servers 110.

In alternative examples, the mobile phone 104 may be an AR or VR headset, a wired or wireless handset, or any other communication device that would benefit from the use of sidetone. Similarly, the wireless ear buds 200 may instead be wired or wireless headsets or headphones of any configuration that would again benefit from the use of sidetone. Similarly, other networks or communication channels may be employed to establish communication between the near and far communication devices.

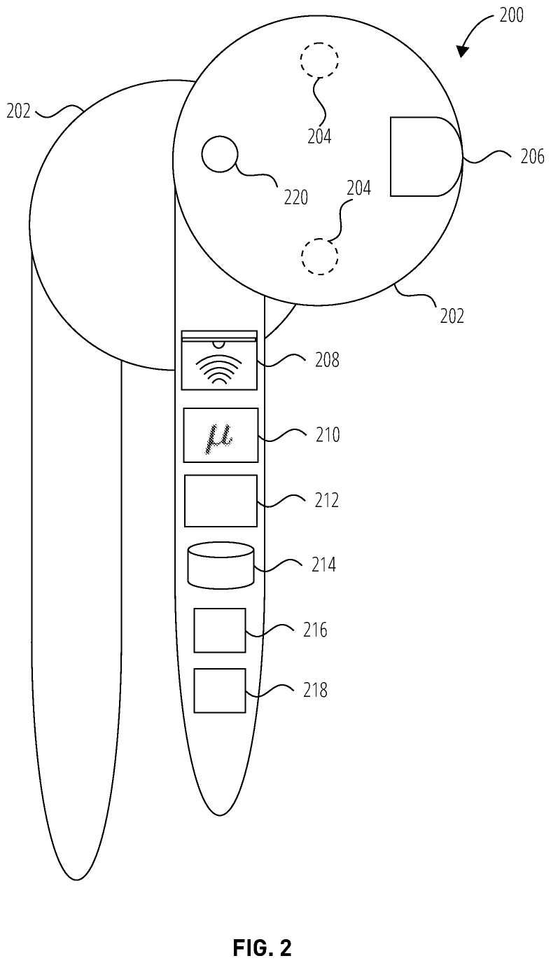

FIG. 2 illustrates the example wireless ear buds 200 of FIG. 1 in more detail. Each wireless ear bud 202 includes a communication interface 208 used to communicatively couple with an audio source or sink device, (such as the mobile phone 104) that can provide audio data for reproduction as an audio signal to a user of the wireless ear buds 200, or that can receive audio data from the wireless ear buds 200. Each wireless ear bud 202 also includes a battery 216 and optionally one or more sensors 204 for detecting a wearing status of the wireless ear buds 200, e.g., when a wireless ear bud 202 is placed in or on and/or removed from an ear.

Additionally, each wireless ear bud 202 includes an audio transducer 206 for converting a received signal including audio data, into audible sound and one or more external microphones 218 for generating ambient and speech signals. A receive audio signal can be received from a paired companion communication device such as mobile phone 104 via the communication interface 208, or alternatively the receive signal may be relayed from one wireless ear bud 202 to the other. A transmit audio signal can be generated from the one or more microphones 218 in the wireless ear buds 200. Also included is an internal microphone 220 that can be used to capture audio in the user's ear canal(s) or in the earcups of over-the-ear headphones or headsets.

One or both of the wireless ear buds 202 include a DSP framework 212 for processing received audio signals and/or signals from the one or more microphones 218, to provide to the audio transducer 206 or a remote user. The DSP framework 212 is a software stack running on a physical DSP core (not shown) or other appropriate computing hardware, such as a networked processing unit, accelerated processing unit, a microcontroller, graphics processing unit or other hardware acceleration. The DSP core will have additional software such as an operating system, drivers, services, and so forth. One or both of the wireless ear bud 202 also include a processor 210 and memory 214. The memory 214 in the wireless ear buds 200 stores firmware for operating the wireless ear buds 200 and for pairing the wireless ear buds 200 with companion communication devices.

Although described herein with reference to wireless ear buds, it will be appreciated that the methods and structures described herein are applicable to any audio device that may benefit therefrom.

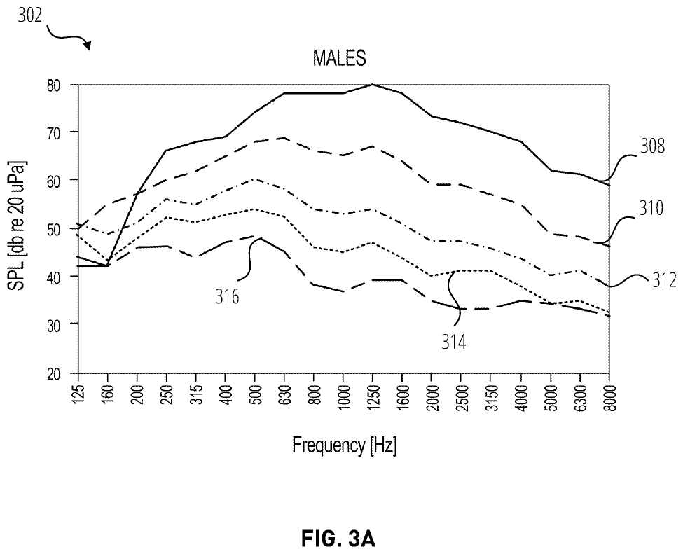

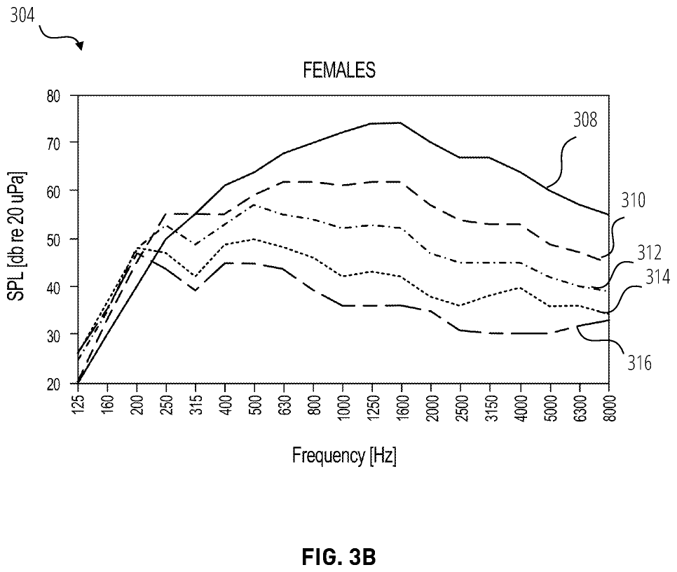

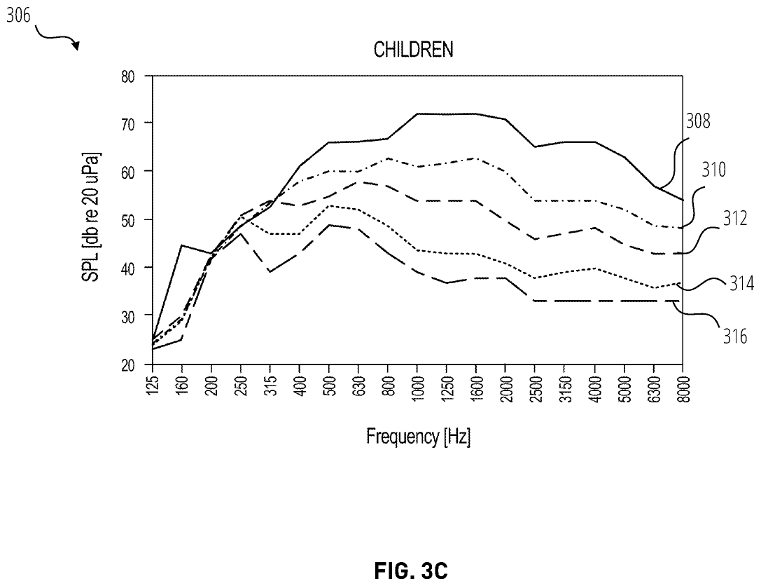

FIGS. 3A to 3C show charts of voice spectral composition for different demographic groups, according to some examples.

FIG. 3A shows a chart 302 with plots of voice spectral composition for males, FIG. 3B shows a chart 304 with plots of voice spectral composition for females, while FIG. 3C shows a chart 306 with plots of voice spectral composition for children. In the figures, spectral plots for voice categories that have been defined as Shouting 308, Loud 310, Raised 312, Normal 314 and Quiet 316 are illustrated. SPL in dB is shown on the y-axis, while frequency is shown on the x-axis.

As can be seen, while there are differences, FIG. 3A, FIG. 3B and FIG. 3C are quite similar. While various techniques can be used to determine the voice category of different users in different demographic groups, in one example, voice categories can be determined for all user from the ratio between the SPL of the middle frequencies (such as between 800 Hz and 1,200 Hz) to the SPL of the low frequencies (such as at approximately 200 Hz). For example, all ratios below a certain minimum value could be defined as Quiet 316, while all ratios above a certain maximum value could be defined as Shouting 308. Intermediate ranges could for the values of the ratio could then be defined as Normal 314, Loud 310, and Raised 312, Of course, the particular values and categories are a matter of design choice and more or less categories, determined using different ratios or methods, could be used.

Since sidetone is feedback that occurs immediately in real time, the instantaneous level of the sidetone will vary in a conventional manner. This may be sufficient for the user to realize, for example, that they are speaking too loudly and to adjust their voice level accordingly. However, if they continue speaking too loudly, then one of the conditions described above may be occurring and the user may not realize that their voice level is inappropriate despite the conventional variation in sidetone level.

In such a case, based on the determined voice category, an additional adjustment to the sidetone level or the sidetone spectral characteristics is provided to influence the user to adjust the level of their speech. The additional sidetone level adjustment is based on the detected voice category, with larger adjustments being made to sidetone levels when louder categories are detected. In some examples, the higher frequencies of the sidetone are boosted by progressively larger values as the user's rises through the increasingly louder voice categories. In other examples, certain frequencies could be de-emphasized. In some examples, in addition to or instead of boosting or de-emphasizing certain frequencies, an overall additional gain could be applied to the sidetone to increase its volume above the normal volume increase in the sidetone.

In some examples, the voice category is determined by a slow time-averaged analysis of voice SPL and spectrum. The instantaneous voice category is often highly dynamic in a conversation, but if an undesirable voice category such as Loud 310 and Shouting 308 is consistently detected over a period of, for example, fifteen to thirty seconds to a minute or so, an overly-loud talking situation has been detected, and the sidetone level is increased and/or the sidetone spectral profile is varied. The spectral analysis could be done by monitoring the output of band-pass filters spaced by ½ or ⅓ octaves logarithmically in frequency up to about 1500 Hz. The output of each would be time-averaged to yield a set of band-specific SPL values that can be matched to the voice category tables or used in a ratio as discussed above. A higher resolution frequency domain analysis would yield more points but would need adequate resolution in the lower frequencies.

The inputs used for determination of the SPL and SPL spectrum are at least the outward-facing microphones 218 on the wireless ear buds 200. Additionally, the internal microphone 220 can be used to detect the SPL inside the user's ear canal microphone on inside an earcup. A calibrated microphone and system may help ensure that the voice category is measured accurately and that the derived sidetone level is delivered adequately.

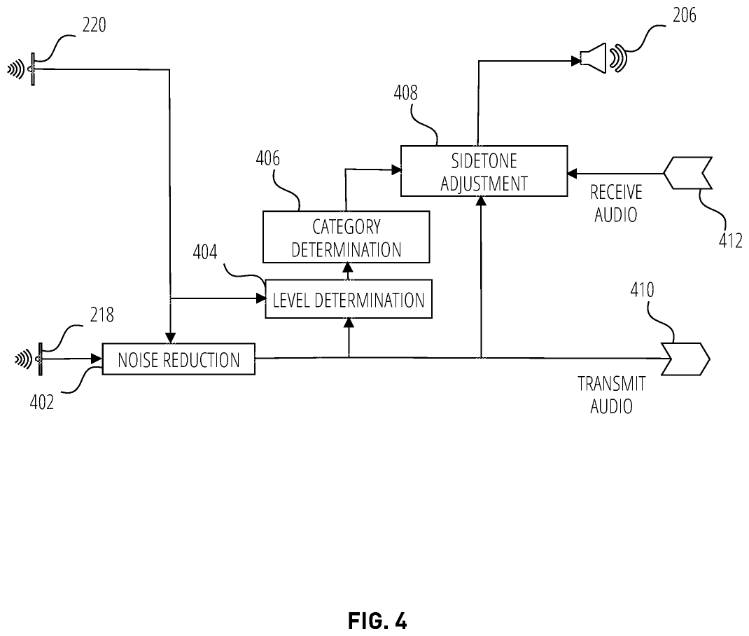

FIG. 4 is a schematic diagram showing a dynamic sidetone adjustment implementation according to some examples. As shown in the figure, a user speech signal is generated by one or more microphones 218, a signal representing the sounds in or at the user's ear is picked up by internal microphone 220, audio output is provided to the user by audio transducer 206. Receive audio (e.g. from remote device 108) is received at input 412 and transmit audio (e.g. for sending to remote device) is provided at output 410.

The speech signal from the microphone 218 is first processed by any noise reduction algorithms at noise reduction module 402, which may also receive the signal from internal microphone 220 for use in the noise reduction algorithms. After performance of any noise reduction in noise reduction module 402, the resulting signal is passed to the level determination module 404 and also to the output 410 as the transmit audio.

The level determination module 404 determines the SPL levels in predetermined frequency bands as discussed above. Also as discussed above, this may be done as an average over a fixed time period to avoid adjusting the SPL with an additional overall gain or with additional gains in particular frequency bands.

The SPL levels for the frequency bands is then passed to the category determination module 406, where the category of the speech level (such as Shouting 308, Loud 310, Raised 312, Normal 314 and Quiet 316) is determined. Based on the category, an adjustment to the SPL level (an additional overall gain or additional gains to specific frequency bands) is provided as discussed above in the sidetone adjustment module 408. The sidetone adjustment module in some examples includes bandpass filters corresponding to those used in the level determination module 404, to separate out frequency bands to which determined gains can be applied, before being recombined into an adjusted speech sidetone signal, which is combined with the receive audio from input 412. The combined signal is then provided to the audio transducer 206.

One way to change the user's behavior is to adjust the level of the sidetone based on the category that is detected. By making the sidetone louder, the user will naturally reduce their speech level. Similarly, if the sidetone is low in level, then the user will naturally speak louder. An example implementation may do the following:

| | Sidetone level |
|---|---|
| Voice category | adjustment |
| Quiet | 0 dB |
| Normal | 0 dB |
| Raised | +10 dB |
| Loud | +20 dB |
| Shouting | +20 dB |
| | (system limit reached) |

In a related implementation, instead of using voice categories, the user's speech level as measured by the external microphone in the headphone or earbud could be used to adjust the sidetone level. For example,

| Measured Voice Level | Sidetone level |
|---|---|
| (dBA) | adjustment |
| 50 dB | −6 dB |
| 55 | −3 dB |
| 60 | 0 dB |
| 66 | +3 dB |
| 72 | +6 dB |

The level adjustments shown in the tables above can be applied to the entire signal (just a gain adjustment), or could also be applied to only certain frequency bands (e.g., frequencies above 800 Hz).

Not shown in FIG. 4 is any processing that might be applied to the receive audio or the combined receive audio and sidetone signal, such as active noise cancellation derived from a signal received from the internal microphone 220.

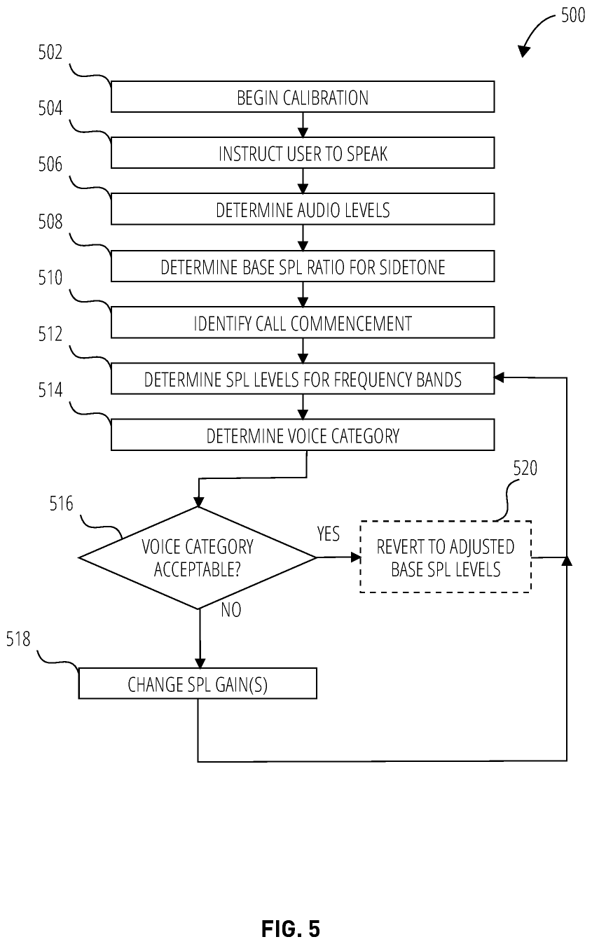

FIG. 5 illustrates a flowchart 500 for providing dynamic sidetone adjustment according to some examples. For explanatory purposes, the operations of the flowchart 500 are described herein as occurring in serial, or linearly. However, multiple operations of the flowchart 500 may occur in parallel. In addition, the operations of the flowchart 500 need not be performed in the order shown and/or one or more blocks of the flowchart 500 need not be performed and/or can be replaced by other operations.

The method is described in the flowchart 500 with reference to processing of the audio signals in the wireless ear buds 202, but this could also take place on the mobile phone 104 alternatively or in addition to in the wireless ear buds 202. Additionally, some or all of the steps, can be provided in a remote device such as a server 110 coupled to the network 102. In such a case, parameters for sidetone adjustment, once determined, can be transmitted to the wireless ear buds 202 and mobile phone 104 for use in adjusting the sidetone that is delivered to the user.

The method commences at operation 502 with a calibration of the sidetone system. In operation 504 an audible or visual prompt is provided to the user by the wireless ear buds 202 or mobile phone 104 to speak normally. In operation 506, the audio levels at the internal microphone 220 and the one or more microphones 218 is determined. An acceptable base SPL ratio or gain is then determined in operation 508, which can be used to generate normal sidetone levels for user speech in the Normal 314 speech category.

In operation 510, the placement of a call (audio and optionally including video) is detected. The level determination module 404 then commences the determination of SPL levels for specified frequency bands in operation 512. The level determination module 404 then determines the relevant voice category in operation 514 from the SPL levels determined in operation 512.

It is then determined if the voice category is acceptable in operation 516. Acceptable voice categories may for example be Raised 312 and Normal 314. In the event that the voice category is determined to be not acceptable, the base SPL ratio or gain is changed, or base SPL ratios or gains are changed for individual frequency bands in operation 518. Providing different gains or different ratios for individual frequency bands provides an exaggerated spectral shape to prompt, consciously or unconsciously, the user to revert to an acceptable voice category. The method then returns to operation 512 and continues until the call ends.

If it is determined that the voice category is acceptable in operation 516, the method then also returns to operation 512 and continues until the call ends. In the event that a dynamic adjustment of the sidetone had previously been provided in operation 518, upon a determination of an acceptable voice category in operation 516, the SPL gain(s) or ratio(s) return to base levels in operation 520.

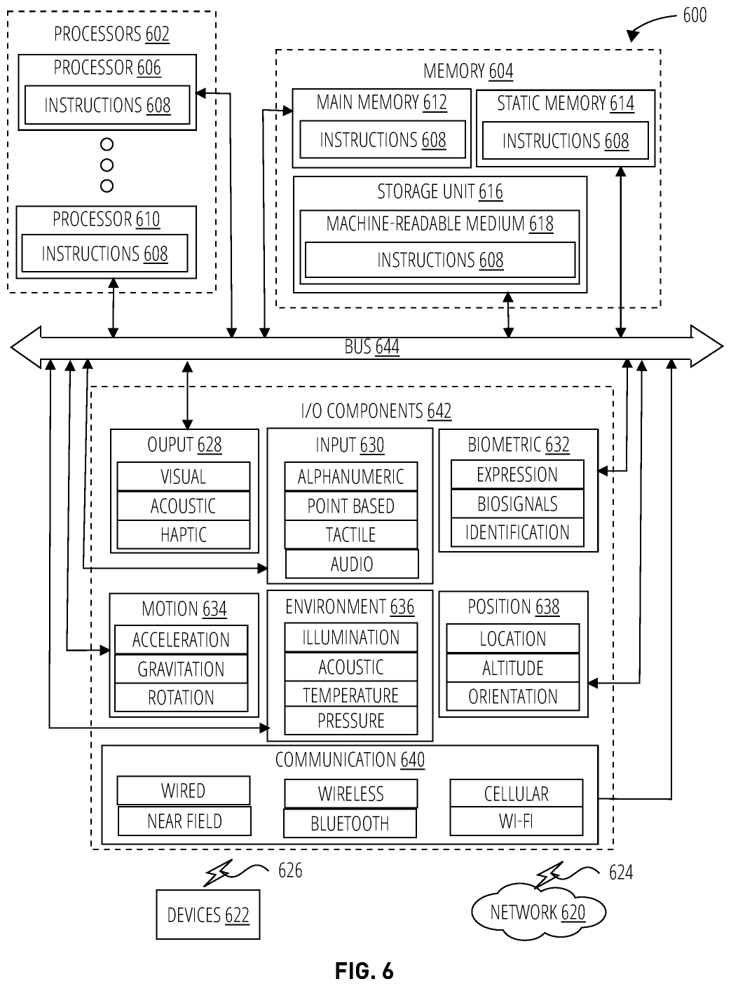

FIG. 6 illustrates a diagrammatic representation of a machine 600 in the form of a computer system within which a set of instructions may be executed for causing the machine to perform any one or more of the methodologies discussed herein, according to some examples. Specifically, FIG. 6 shows a diagrammatic representation of the machine 600 in the example form of a computer system, within which instructions 608 (e.g., software, a program, an application, an applet, an app, or other executable code) for causing the machine 600 to perform any one or more of the methodologies discussed herein may be executed. For example the instructions 608 may cause the machine 600 to execute the methods described above. The instructions 608 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, which specify actions to be taken by the machine 600. Further, while only a single machine 600 is illustrated, the term “machine” shall also be taken to include a collection of machines 600 that individually or jointly execute the instructions 608 to perform any one or more of the methodologies discussed herein.

The machine 600 may include processors 602, memory 604, and I/O components 642, which may be configured to communicate with each other such as via a bus 644. In an example embodiment, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that may execute the instructions 608. The term “processor” is intended to include multi-core processors that may comprise two or more independent processors (sometimes referred to as “cores”) that may execute instructions contemporaneously. Although FIG. 6 shows multiple processors 602, the machine 600 may include a single processor with a single core, a single processor with multiple cores (e.g., a multi-core processor), multiple processors with a single core, multiple processors with multiples cores, or any combination thereof.

The memory 604 may include a main memory 612, a static memory 614, and a storage unit 616, both accessible to the processors 602 such as via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 within the storage unit 616, within at least one of the processors 602 (e.g., within the processor's cache memory), or any suitable combination thereof, during execution thereof by the machine 600.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones will likely include a touch input device or other such input mechanisms, while a headless server machine will likely not include such a touch input device. It will be appreciated that the I/O components 642 may include many other components that are not shown in FIG. 6. The I/O components 642 are grouped according to functionality merely for simplifying the following discussion and the grouping is in no way limiting. In various example embodiments, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 642 may include biometric components 632, motion components 634, environmental components 636, or position components 638, among a wide array of other components. For example, the biometric components 632 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 may include acceleration sensor components (e.g., accelerometer), gravitation sensor components, rotation sensor components (e.g., gyroscope), and so forth. The environmental components 636 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 may include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 622 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

The various memories (i.e., memory 604, main memory 612, static memory 614, and/or memory of the processors 602) and/or storage unit 616 may store one or more sets of instructions and data structures (e.g., software) embodying or utilized by any one or more of the methodologies or functions described herein. These instructions (e.g., the instructions 608), when executed by processors 602, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 620 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 620 or a portion of the network 620 may include a wireless or cellular network, and the coupling 624 may be a Code Division Multiple Access (CDMA) connection, a Global System for Mobile communications (GSM) connection, or another type of cellular or wireless coupling. In this example, the coupling 624 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 608 may be transmitted or received over the network 620 using a transmission medium via a network interface device (e.g., a network interface component included in the communication components 640) and utilizing any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 608 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method for providing sidetone adjustment, the method comprising:
receiving an audio signal representing speech of a user;
determining a spectral distribution of the audio signal;
determining a voice category from the spectral distribution of the audio signal;
applying an adjustment to the audio signal, based on the determined voice category, to generate an adjusted audio signal; and
providing audio output based on the adjusted audio signal to the user as sidetone.

2. The method of claim 1, wherein the adjustment to the audio signal comprises adjustments to a plurality of frequency bands in the audio signal.

3. The method of claim 2, wherein the adjustments to a plurality of frequency bands comprise boosting levels of one or more frequency bands in a high frequency speech range.

4. The method of claim 3, further comprising:
applying an additional gain to the audio output for louder voice categories.

5. The method of claim 1, further comprising:
determining a base audio adjustment for the audio signal based on a comparison between a level of the audio signal and a level of a further audio signal captured at or in an ear of the user.

6. The method of claim 1, wherein the voice category is determined by comparing a level of a low frequency speech band in the audio signal with a level of a mid-frequency speech band in the audio signal.

7. The method of claim 6, wherein the voice category is determined from a ratio of the level of the low frequency speech band and the level of a mid-frequency speech band.

8. A computing apparatus for providing sidetone adjustment, the computing apparatus comprising:
one or more computer processors; and
one or more memories storing instructions that, when executed by the one or more computer processors, configure the computing apparatus to perform operations comprising:
receiving an audio signal representing speech of a user;
determining a spectral distribution of the audio signal;
determining a voice category from the spectral distribution of the audio signal;
applying an adjustment to the audio signal, based on the determined voice category, to generate an adjusted audio signal; and
providing audio output based on the adjusted audio signal to the user as sidetone.

9. The computing apparatus of claim 8, wherein the adjustment to the audio signal comprises adjustments to a plurality of frequency bands in the audio signal.

10. The computing apparatus of claim 9, wherein the adjustments to a plurality of frequency bands comprise boosting levels of one or more frequency bands in a high frequency speech range.

11. The computing apparatus of claim 10, wherein the operations further comprise:
applying an additional gain to the audio output for louder voice categories.

12. The computing apparatus of claim 8, wherein the operations further comprise:
determining a base audio adjustment for the audio signal based on a comparison between a level of the audio signal and a level of a further audio signal captured at or in an ear of the user.

13. The computing apparatus of claim 8, wherein the voice category is determined by comparing a level of a low frequency speech band in the audio signal with a level of a mid-frequency speech band in the audio signal.

14. The computing apparatus of claim 13, wherein the voice category is determined from a ratio of the level of the low frequency speech band and the level of a mid-frequency speech band.

15. A non-transitory computer-readable storage medium, the computer-readable storage medium including instructions that when executed by one or more computer processors of one or more computing devices, cause the one or more computing devices to perform operations for providing sidetone adjustment, the operations comprising:
receiving an audio signal representing speech of a user;
determining a spectral distribution of the audio signal;
determining a voice category from the spectral distribution of the audio signal;
applying an adjustment to the audio signal, based on the determined voice category, to generate an adjusted audio signal; and
providing audio output based on the adjusted audio signal to the user as sidetone.

16. The computer-readable storage medium of claim 15, wherein the adjustment to the audio signal comprises adjustments to a plurality of frequency bands in the audio signal.

17. The computer-readable storage medium of claim 16, wherein the adjustments to a plurality of frequency bands comprise boosting levels of one or more frequency bands in a high frequency speech range.

18. The computer-readable storage medium of claim 17, wherein the operations further comprise:
applying an additional gain to the audio output for louder voice categories.

19. The computer-readable storage medium of claim 15, wherein the operations further comprise:
determining a base audio adjustment for the audio signal based on a comparison between a level of the audio signal and a level of a further audio signal captured at or in an ear of the user.

20. The computer-readable storage medium of claim 15, wherein the voice category is determined by comparing a level of a low frequency speech band in the audio signal with a level of a mid-frequency speech band in the audio signal.
